(19) United States
(12) Patent Application Publication
(10) Pub. No.: US 2014/0080052 A1
(43) Pub. Date: Mar. 20, 2014

(54) CARRIER FOR TWO-COMPONENT DEVELOPER, ELECTROSTATIC LATENT IMAGE DEVELOPER, AND IMAGE FORMING METHOD

(71) Applicants: Shigenori YAGUCHI, Shizuoka (JP); Hiroshi TOHMATSU, Shizuoka (JP); Koichi SAKATA, Shizuoka (JP); Hitoshi IWATSUKI, Shizuoka (JP); Hiroyuki KISHIDA, Shizuoka (JP); Toyoaki TANO, Shizuoka (JP); Kenichi MASHIKO, Shizuoka (JP)

(72) Inventors: Shigenori YAGUCHI, Shizuoka (JP); Hiroshi TOHMATSU, Shizuoka (JP); Koichi SAKATA, Shizuoka (JP); Hitoshi IWATSUKI, Shizuoka (JP); Hiroyuki KISHIDA, Shizuoka (JP); Toyoaki TANO, Shizuoka (JP); Kenichi MASHIKO, Shizuoka (JP)

(21) Appl. No.: 13/960,965

(22) Filed: Aug. 7, 2013

(30) Foreign Application Priority Data
Sep. 18, 2012 (JP) 2012-204202
Mar. 14, 2013 (JP) 2013-051404

(51) Int. Cl. G03G 9/00

(52) U.S. Cl. CPC G03G 15/0928
USPC 430/111.3

(57) ABSTRACT

A carrier for developing electrostatic latent images produced in an image developer includes a magnetic particulate core material and a covering layer covering the surface of the core material. The image developer includes an image bearer, a developer bearer including comprising a magnetic field generator inside and a developer regulation member facing the surface of the image developer with a predetermined gap. The carrier has a bulk density of from 1.6 to 2.25 g/cm³, a BET specific surface area of from 0.5 to 2.0 m³/g, a saturated magnetization (σ5000) not less than 70 emu/g at 5 kOe, and a residual magnetization (σr) not greater than 2 emu/g.

### CROSS-REFERENCE TO RELATED APPLICATIONS

This patent application is based on and claims priority pursuant to 35 U.S.C. §119 to Japanese Patent Applications Nos. 2012-204202 and 2013-051404, filed on Sep. 18, 2012 and Mar. 14, 2013, respectively in the Japan Patent Office, the entire disclosures of which are hereby incorporated by reference herein.

### BACKGROUND

1. Technical Field

The present invention relates to a carrier for developing electrostatic latent images for use in electrophotographic methods and electrostatic recording methods, and an electrostatic latent image developer, a supplemental developer and an image forming method using the carrier.

2. Description of the Related Art

In electrophotographic image formation, an electrostatic latent image is formed on an image bearing member comprising a photoconductive material, and the electrostatic latent image is developed into a toner image with a charged toner. The toner image is then transferred onto and fixed on a recording medium. In the field of electrophotography, full-color copiers and printers have been brought to the mainstream in place of monochrome copiers and printers recently.

In a typical full-color image formation, toner layers of yellow, magenta, cyan, and optional black are superimposed on one another to reproduce various colors, and the resulting composite toner image is finally fixed on a recording medium.

Conventionally, one-component developing methods, two-component developing methods and hybrid developing methods are used. In order to produce clear full-color images having good color reproducibility, a toner amount on an electrostatic latent image bearer needs maintaining faithfully to an electrostatic latent image. When the toner amount on an electrostatic latent image bearer varies, the image density varies on a recording medium or color tone varies.

The toner amount on the electrostatic latent image bearer varies because the toner varies in charge quantity or a following image takes over a history of the last image (ghost phenomenon) in the hybrid developing methods.

The ghost phenomenon is a phenomenon in which the toner amount on a toner bearer varies according to a toner consumption pattern of the last image and the following image varies in image density, which is a specific problem of the hybrid developing method.

This is because, in the hybrid developing method, a specific amount of a toner is constantly fed to the toner bearer and the amount of a toner thereon varies according to the number of receiving a toner.

Namely, after an image consuming less toner is printed, the toner remaining on the toner bearer increases, and after the toner is fed, the toner amount on the toner bearer further increases, and the resultant image has higher image density.

Meanwhile, after an image consuming much toner is printed, the toner remaining on the toner bearer decreases, and after the toner is fed, the toner amount on the toner bearer decreases, and the resultant image has lower image density.

As mentioned above, the ghost phenomenon in the hybrid developing method is caused by the toner amount variation on the toner bearer when a following image is produced according to the history of the last image because it is difficult to uniform the amount of the decreased toner after used for development and the amount of the undeveloped toner remaining on the toner bearer when the toner is transferred onto the toner bearer from a two-component developer.

In order to solve these problems, Japanese Patent No. JP-3356948-B (Japanese published unexamined application No. JP-H09-251237-A), and Japanese published unexamined applications Nos. JP-2005-157002-A and JP-H11-231652-A disclose scraping off the toner remaining on the toner bearer therefrom with a scraper or a toner collection roller after developed and before fed again.

Japanese published unexamined application No. JP-H07-72733-A discloses a method of collecting the toner remaining on the toner bearer on a magnetic roller by potential difference between copyings or papers to stabilize the toner amount on the toner bearer.

Further, in order to solve the problem of history development using the magnetic brush, Japanese published unexamined application No. JP-H07-128983-A discloses widening a half width area of a magnetic flux density of the magnetic roll to collect and feed the toner on the toner bearer.

Japanese published unexamined application No. JP-H07-92813-A discloses a method of using a non-spherical carrier to increase the surface area thereof and increasing a ratio of the carriers contacting each other to charge the carrier even at the end of the magnetic brush, narrowing a substantial gap between the developer bearer and the toner bearer to increase the toner amount fed to the toner bearer at a time, and feeding the toner until the toner bearer is saturated with the toner to maintain a specific amount of the toner on the toner bearer and prevent an influence of the last image history.

Even the two-component developing method has the ghost phenomenon as disclosed in Japanese published unexamined application No. JP-H11-65247-A. Poor separation of the developer is thought to cause the ghost phenomenon, which is different from that of the hybrid developing method.

The two-component developing method has an odd number of magnets in the developer bearer and a pair of magnets having the same polarity below the rotational axis of the developing sleeve to form a separation area where a magnetic force is almost zero. The developer naturally falls there by gravity to separate from the developer bearer.

However, the carrier has a counter charge when the toner is consumed in the last image, and an image force generates between the carrier and the developer bearer and the developer does not separate at the separation area. The toner is consumed and the developer having a lowered toner concentration is fed to the developing area again, resulting in production of images having low image density.

Namely, images having normal image density are produced for one cycle of the sleeve, but the image density lowers since the second cycle, resulting in the ghost phenomenon.

In order to solve these problems, Japanese published unexamined application No. JP-H11-65247-A discloses a configuration of locating a scoop roll having a magnet inside at the separation area above the developer bearer to separate the developer after developed by the magnetic force.

The separated developer is further scooped up by another scoop roll, and fed to a developer stirring chamber where the toner concentration is adjusted again and the toner is charged.

Japanese published unexamined application No. JP-2004-77568-A discloses a carrier using a core material formed of a porous magnetic material including a high-resistivity material (resin) having a resistivity higher than that of the porous magnetic material to prevent carrier adherence, background fouling and white spots.

Japanese published unexamined applications Nos. JP-2009-20145-A and JP-2009-175666-A disclose a carrier formed of a porous ferrite core material having a desired pore capacity and a resin filled in the pore.

Japanese published unexamined application No. JP-2009-205149-A discloses a magnetic particulate material including a resin having a desired density and a desired true density to prevent carrier adherence, improve dot reproducibility of electrostatic latent image, and prevent deterioration of image density of the rear end of a solid image.

Japanese published unexamined application No. JP-2011-112960-A discloses a carrier maintaining a pore capacity and a peak pore diameter in a specific range to have fluidity and desired magnetization and resistivity.

Japanese published unexamined application No. JP-2011-150253-A discloses a carrier formed of a porous ferrite particulate material, including MgO and/or Fe₂O₃ partially substituted with SrO, to lower variation of magnetization between the carriers.

Japanese published unexamined application No. JP-2011-158830-A discloses a carrier including porous magnetic particles and a resin. The carrier has a specified number of regions of porous magnetic particle portions, having a length of 6.0 μm or more in the porous magnetic particle and a specified number of regions except porous magnetic particle portions having a length of 4.0 μm or more.

Japanese published unexamined applications Nos. JP-2011-164225-A and JP-2012-58344-A disclose a durable and long-life resin-filled carrier having a low specific gravity and weight.

Japanese published unexamined application No. JP-2012-83781-A discloses a carrier formed of a porous magnetic core coated with a resin. The carrier is likely to break down (be conductive) when applied with high voltage. When the porous magnetic core has a desired range of airspace, the carrier improves in maintaining high resistivity and spent resistance.

However, these carriers use porous core materials to have low density, but the core materials have many convexities and concavities and a covering layer needs to be thick to prevent the core materials from being exposed, resulting in deterioration of magnetization of the carrier.

A porous ferrite and a porous magnetic core having low weight have low magnetization, resulting in carrier adherence.

The occurrence mechanism of the ghost phenomenon in the present invention is thought as follows.

Even when a developer normally leaves by a developer leaving polarity, the ghost phenomenon occurs. The image density does not become lower but becomes higher than that of the last image. A toner adheres onto a developer bearer according to the last image history, and a toner development amount of the following image varies according to a potential of the toner having adhered onto the developer bearer. Namely, the ghost phenomenon is caused by variation of the toner development amount of the following image due to the last image history.

In detail, the toner adherence to the developer bearer occurs because the toner is developed onto the developer bearer when a bias is applied in a developing sleeve direction in forming non-image part. The toner developed onto the developer bearer has a potential and the toner development amount increases by the potential thereof in printing.

Due to a residual magnetization of the carrier, a developer does not normally leave by the developer leaving polarity, and a developer having low toner concentration is fed to a developing area, resulting in production of images having low image density.

Namely, even in a two-component developing method, an amount of a toner on a developer bearer is not constant and varies according to the history of the last image.

Namely, when the last image has no image or between papers, a toner is developed on the developer bearer and adheres thereon, resulting in higher image density. When the last image has a large image area, a toner on the developer bearer decreases, resulting in production of images having lower image density.

The object of the present invention is a ghost phenomenon in which a toner development amount on a developer bearer varies according to the last image, resulting in variation of image density of the following image.

Because of these reasons, a need exist for a carrier producing clear images having good color reproducibility, and developing a toner in a constant amount without influence of a toner consumption history of the last image.

### SUMMARY

Accordingly, one object of the present invention is to provide a carrier producing clear images having good color reproducibility, and developing a toner in a constant amount without influence of a toner consumption history of the last image. Further, the carrier has stable chargeability for long periods, good hardness and durability (flexibility and elasticity), and good abrasion (scrape and peel) resistance, varies less in resistivity and the chargeability due to spent of toner compositions, and prevents environmental variation of the chargeability without variation of image density, background fouling and inner contamination due to toner scattering even in various usage environments.

Another object of the present invention is to provide a developer using the carrier.

A further object of the present invention is to provide a supplemental developer using the carrier.

Another object of the present invention is to provide an image forming method using a developer including the carrier.

These objects and other objects of the present invention, either individually or collectively, have been satisfied by the discovery of a carrier, including a magnetic particulate core material; and a covering layer covering the surface of the core material, for developing electrostatic latent images produced in an image developer comprising an image bearer; a developer bearer comprising a magnetic field generator inside; and a developer regulation member facing the surface of the image developer with a predetermined gap. The carrier has a bulk density of from 1.6 to 2.25 g/cm³, a BET specific surface area of from 0.5 to 2.0 m³/g, a saturated magnetization (σ5000) not less than 70 emu/g at 5 kOe, and a residual magnetization (σr) not greater than 2 emu/g.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of image developer executing the image forming method of the present invention;

FIG. 2 is a schematic view illustrating an embodiment of image forming apparatus executing the image forming method of the present invention;

FIG. 3 is a schematic view illustrating another embodiment of image forming apparatus executing the image forming method of the present invention;

FIG. 4 is a schematic view illustrating an embodiment of process cartridge of the present invention;

FIG. 5 is a perspective view illustrating a resistivity measuring cell used for measuring electric resistivity of a carrier;

FIG. 6 is a schematic view illustrating a method of measuring a charge quantity of a developer in the present invention;

FIG. 7 is a schematic view illustrating a normal image and a ghost image in each vertical band chart.

### DETAILED DESCRIPTION

The present invention provides a carrier producing clear images having good color reproducibility, and developing a toner in a constant amount without influence of a toner consumption history of the last image. Further, the carrier has stable chargeability for long periods, good hardness and durability (flexibility and elasticity), and good abrasion (scrape and peel) resistance, varies less in resistivity and the chargeability due to spent of toner compositions, and prevents environmental variation of the chargeability without variation of image density, background fouling and inner contamination due to toner scattering even in various usage environments.

When a carrier has a bulk density not greater than 2.25 g/cm³, the ghost phenomenon is improved. The number of a carrier having low bulk density can be increased in a developing nip and substantial resistivity in the developing nip can be decreased. A toner developed on a developer bearer when is difficult to consume when printing. An amount of a toner on the developer bearer is stabilized regardless of the last image, and it is thought uniform images are produced.

When a carrier has too low bulk density, a force attracting the carrier to a magnet roll decreases, resulting in carrier adherence. Therefore, the bulk density has a minimum.

In order to increase the force attracting the carrier to the magnet roll, the magnetization of the carrier itself is an important factor as well.

The higher a saturated magnetization of the carrier, the higher the force attracting the carrier to the magnet roll. The carrier has a saturated magnetization (σ5000) not less than 70 emu/g. When less than 70 emu/g, the carrier adherence is likely to occur.

When a toner concentration is low and a potential of a photoreceptor is high, a carrier is likely to adhere to a solid image. When a developer has high charge quantity and a photoreceptor has a high potential, a carrier is likely to adhere to an edge of an image.

A carrier having a saturated magnetization (σ5000) not less than 70 emu/g and a bulk density not less than 1.6 g/cm³ can prevent itself from adhering so as not to cause a problem in practical use.

The carrier has a residual magnetization (σr) not greater than 2 emu/g. In an image developer, a developer on a developer bearer is separated therefrom and a new developer is fed thereto. When the residual magnetization is large, a developer is difficult to separate from a developer bearer. A developer having low toner concentration due to the last development cannot be separated therefrom, and developability lowers in the following development, occasionally resulting in influence of the last image history on the following image.

The higher speed a magnet roller rotates, the more difficult a developer separates therefrom. In consideration of a developer used in high-speed image forming apparatuses, the carrier preferably has a residual magnetization (σr) not greater than 2 emu/g.

### <Carrier Core Material>

Known magnetic materials can be used for a particulate core material of the carrier of the present invention, provided they develop a spontaneous magnetization. Specific examples thereof include, but are not limited to, ferromagnetic materials such as iron and cobalt; iron oxides such as magnetite, hematite and ferrite; various metal alloys and compounds: and materials formed of a resin in which these magnetic materials are dispersed. Particularly, Mn ferrites and Mn—Mg ferrites are preferably used in terms of magnetization.

The particulate core material of the carrier of the present invention preferably has low bulk density and BET specific surface resistivity, and high magnetization.

The particulate core material of the carrier preferably has a bulk density of from 1.5 to 2.2 g/cm³. When less than 1.5 g/cm³, the carrier has low magnetization, resulting in occasional carrier adherence. When greater than 2.2 g/cm³, the carrier occasionally decreases in number.

As a method of reducing bulk density, the temperature or time of burning the core material has been decreased to stop crystallization. The core material is likely to have convexities and concavities or small space gaps on its surface, and the convexities are likely to be exposed when the covering layer is abraded while the carrier is stirred in an image developer.

When the core material has many convexities and concavities on its surface, the covering layer at the convexities are likely to be abraded after used for long periods in an image developer. The core material is exposed so much that a difference in resistivity before and after use becomes large. An amount of a toner on an electrostatic latent image bearer varies, resulting in unstable image quality.

The more the carrier adherence on a solid image is likely to occur, the lower the resistivity of the carrier. The more exposed the convexities of the carrier, the more the carrier adherence on a solid image is likely to occur.

When a core material having many convexities and concavities on its surface is used, the carrier adherence on a solid image does not occur initially, but the covering layer is abraded by stirring in an image developer and the convexities of the carrier is exposed, resulting in worsening of the carrier adherence on a solid image.

In order to prevent this, the covering layer needs to be thick, and the thick covering layer deteriorates magnetization of the carrier.

Further, a core material having many convexities and concavities, and air spaces deteriorates in magnetization when oxidized to have high resistivity.

The convexities and concavities on the surface of a core material can be represented by BET specific surface area, and the core material of the present invention preferably has a weight-average particle diameter of from 20 to 55 μm, and a BET specific surface area of from 0.09 to 20 m³/g.

A core material having the BET specific surface area has a few convexities and concavities. An amount of a toner on an electrostatic latent image bearer does not vary and worsening of the carrier adherence can be prevented.

In order to prepare a core material having low bulk density, high magnetization and a BET specific surface area of from 0.09 to 20 m3/g, a volatile material is included in a core material composition before burned and the volatile material leaves when burned to form air space decreasing bulk density.

At the beginning of burning, the volatile material vaporizes to form an air gap in the core material. Then, as the core material is burned at high temperature, an air hole at the surface of the core material becomes small or buried, and the air hole is closed in.

The surface of a core material has less convexities and concavities when burned at high temperature, decreases in surface space holes and has small BET specific surface area. Therefore, even when the core material is oxidized to have high resistivity, the magnetization thereof is difficult to lower and high magnetization can be maintained.

The volatile components include SiO₂, Al₂O₃, Al(OH)₂, etc. The content thereof controls the bulk density of a core material. The content thereof is preferably less than 50% by weight because the core material includes many space holes and deteriorates in strength when the content is too large.

A core material is burned at from 200 to 700° C. and oxidized, and an oxidized film is formed on the surface thereof to have higher resistivity.

### <Covering Layer>

The carrier of the present invention has a BET specific surface area of from 0.5 to 2.0 m³/g after coated.

When less than 0.5 m³/g, the core material is easily exposed and carrier adherence is likely to occur.

When greater than 2.0 m³/g, the carrier deteriorates in magnetization and has too high resistivity, resulting in ghost phenomena.

When hydrophobic resins such as silicone resins are used, the resin layer is likely to have a crosslinked structure and has more BET specific surface area than the core material alone. The thickness of the resin layer is controlled by the content of the resin relative to the core material. When too thin, the core material is easily exposed when stirred in an image developer and the resistivity largely varies. When too thick, the carrier deteriorates in magnetization. Therefore, the content of the resin is preferably from 0.5 to 7.5% by weight per 100 parts by weight of the core material.

### <Coated Resin>

The coated resin is formed with a composition including a silicone resin having a silanol group and/or a hydrolyzable functional group, a polymerization catalyst and a solvent, and resin besides the silicone resin having a silanol group and/or a hydrolyzable functional group when necessary.

Specifically, the covering layer may be formed by condensing the silanol group while or after coating the particulate core material with the compositions for forming the covering layer.

Specific examples of the method of condensing the silanol group while coating the particulate core material with the compositions include, but are not limited to, a method of coating the particulate core material with the compositions while applying heat or light thereto.

Specific examples of the method of condensing the silanol group after coating the particulate core material with the compositions include, but are not limited to, a method of heating the compositions after coating the particulate core material therewith.

Specific examples of resins besides the silicone resin having a silanol group and/or a hydrolyzable functional group include, but are not limited to, acrylic resins, amino resins, polyvinyl resins, polystyrene resins, halogenated olefin resins, polyester resins, polycarbonate resins, polyethylene resins, polyvinyl fluoride resins, polyvinylidene fluoride resins, poly(trifluoroethylene) resins, poly(hexafluoropropylene) resins, copolymer of vinylidene fluoride and vinyl fluoride, fluoroterpolymer (e.g., terpolymer of tetrafluoroethylene, vinylidene fluoride, and a non-fluoride monomer), and silicone resins having no silanol group and/or no hydrolyzable group. Two or more of these resins can be used in combination.

In addition, a resin including a crosslinked material formed by hydrolyzing a copolymer having the following formula (I) to produce and condensing a silanol group can be used as well:

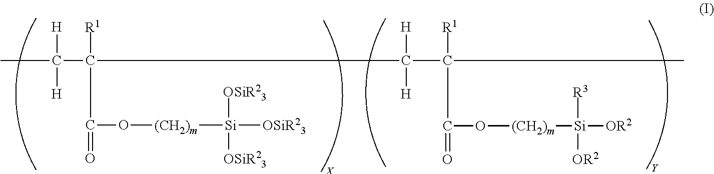

wherein R¹ represents a hydrogen atom or a methyl group; m represents an integer of from 1 to 8; R² represents an aliphatic hydrocarbon group such as methyl groups, ethyl groups propyl groups and butyl groups having 1 to 4 carbon atoms; R³ represents alkyl groups such as methyl groups, ethyl groups, propyl groups and butyl groups having 1 to 8 carbon atoms or alkoxy groups such as methoxy groups, ethoxy groups, propoxy groups and butoxy groups having 1 to 4 carbon atoms; X and Y represent 10 to 90% by mol, respectively.

### <Filler>

The covering layer of the present invention may include a filler.

The covering layer preferably includes a filler in an mount of from 50 to 500 parts by weight, and more preferably from 100 to 350 parts by weight per 100 parts by weight of the resin.

A covering layer including a specific amount of the filler prevents itself from being abraded when used for long periods in an image developer. When less than 50 parts by weight, the effect of preventing abrasion of the covering layer decreases. When greater than 500 parts by weight, a ratio of the resin on the surface of the carrier is relatively small and a toner is likely to be spent thereon.

The filler preferably has a particle diameter of from 50 to 800 nm, and more preferably from 300 to 700 nm.

The filler easily appears from the surface of the covering layer such that the carrier partially has low resistivity, and further materials spent on the surface of the carrier are easy to scrape and the carrier has good abrasion resistance.

One hundred filler images amplified at 10,000 times using FE-SEM (S-800) from Hitachi Ltd. were randomly sampled were randomly sampled and a number-average particle diameter thereof was determined as a particle diameter of the filler.

The filler resistivity is a volume resistivity measured by a powder resistivity measuring system MCP-PD51 from DIAINSTRUMENTS CO., LTD. with a four-terminal & four-probe Loresta GP under the following conditions.

Sample: 1.0 g

Electrode gap: 3 mm

Sample radius: 10.0 mm

Load: 20 kN

An electroconductive filler or a non-electroconductive filler can be used as the filler, and can be combined.

Specific examples of the electroconductive filler include fillers including substrates such as aluminum oxide, titanium dioxide, zinc oxide, silicon dioxide, barium sulfate and zirconium oxide and layers such as a tin dioxide layer and a indium oxide overlying the substrate; and carbon black. The aluminum oxide, titanium dioxide and barium sulfate are preferably used.

Specific examples of the non-electroconductive filler include substrates such as aluminum oxide, titanium dioxide, zinc oxide, silicon dioxide, barium sulfate and zirconium oxide.

### <Silane Coupling Agent>

In the present invention, the compositions for forming the covering layer preferably include a silane coupling agent stably dispersing the filler.

Specific examples of usable silane coupling agents include, but are not limited to, γ-(2-aminoethyl)aminopropyl trimethoxysilane, γ-(2-aminoethyl)aminopropylmethyl dimethoxysilane, γ-methacryloxypropyl trimethoxysilane, N-β-(N-vinylbenzylaminoethyl)-γ-aminopropyl trimethoxysilane hydrochloride, γ-glycidoxypropyl trimethoxysilane, γ-mercaptopropyl trimethoxysilane, methyl trimethoxysilane, methyl triethoxysilane, vinyl triacetoxysilane, γ-chloropropyl trimethoxysilane, hexamethyl disilazane, γ-anilinopropyl trimethoxysilane, vinyl trimethoxysilane, octadecyldimethyl[3-(trimethoxysilyl)propyl]ammonium chloride, γ-chloropropylmethyl dimethoxysilane, methyl trichlorosilane, dimethyl dichlorosilane, trimethyl chlorosilane, allyl triethoxysilane, 3-aminopropylmethyl diethoxysilane, 3-aminopropyl trimethoxysilane, dimethyl diethoxysilane, 1,3-divinyltetramethyl disilazane, and methacryloxyethyldimethyl(3-trimethoxysilylpropyl) ammonium chloride. Two or more of these materials can be used in combination.

Specific examples of commercially-available silane coupling agents include, but are not limited to, AY43-059, SR6020, SZ6023, SH6026, SZ6032, SZ6050, AY43-310M, SZ6030, SH6040, AY43-026, AY43-031, sh6062, Z-6911, sz6300, sz6075, sz6079, sz6083, sz6070, sz6072, Z-6721, AY43-004, Z-6187, AY43-021, AY43-043, AY43-040, AY43-047, Z-6265, AY43-204M, AY43-048, Z-6403, AY43-206M, AY43-206E, Z6341, AY43-210MC, AY43-083, AY43-101, AY43-013, AY43-158E, Z-6920, and Z-6940 (from Dow Corning Toray Co., Ltd.).

The content of the silane coupling agent is preferably 0.1 to 10% by weight based on the silicone resin. When the content of the silane coupling agent is too small, adhesiveness between the silicone resin and the core particle or conductive particle may be poor. When the content of the silane coupling agent is too large, toner filming may occur in a long-term use.

### <Toner>

The carrier of the present invention is mixed with a toner to be used as a two-component developer.

The toner comprises a binder resin (e.g., a thermoplastic resin), a colorant, a charge controlling agent, a release agent, fine particles, etc.

The toner may be obtained by various manufacturing methods such as polymerization methods and granulation methods, and have either an irregular or spherical shape. The toner may be either magnetic or non-magnetic.

Specific examples of usable binder resins for the toner include, but are not limited to, styrene-based resins (e.g., homopolymers of styrene or styrene derivatives such as polystyrene and polyvinyl toluene; and styrene-based copolymers such as styrene-p-chlorostyrene copolymer, styrene-propylene copolymer, styrene-vinyltoluene copolymer, styrene-methyl acrylate copolymer, styrene-ethyl acrylate copolymer, styrene-butyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-maleic acid copolymer, styrene-maleate copolymer), acrylic resins (e.g., polymethyl methacrylate, polybutyl methacrylate), polyvinyl chloride, polyvinyl acetate, polyethylene, polypropylene, polyester, polyurethane, epoxy resin, polyvinyl butyral, polyacrylic acid resin, rosin, modified rosin, terpene resin, phenol resin, aliphatic or alicyclic hydrocarbon resin, aromatic petroleum resin, chlorinated paraffin, and paraffin wax. Two or more of these resins can be used in combination.

Among these resins, polyester resins are preferable because they can have lower viscosity when melted while keeping better storage stability than styrene-based or acrylic resins.

The polyester resin can be obtained from a polycondensing reaction between an alcohol and a carboxylic acid.

Specific examples of suitable alcohols include, but are not limited to, diols (e.g., polyethylene glycol, diethylene glycol, triethylene glycol, 1,2-propylene glycol, 1,3-propylene glycol, 1,4-propylene glycol, neopentyl glycol, 1,4-butenediol), etherified bisphenols (e.g., 1,4-bis(hydroxymethyl)cyclohexane, bisphenol A, hydrogenated bisphenol A, polyoxyethylenated bisphenol A, polyoxypropylenated bisphenol A), divalent alcohols in which the above compounds are substituted with a saturated or unsaturated hydrocarbon group having 3 to 22 carbon atoms, other divalent alcohols, and tri- or more valent alcohols (e.g., sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene).

Specific examples of suitable carboxylic acids include, but are not limited to, monocarboxylic acids (e.g., palmitic acid, stearic acid, oleic acid), maleic acid, fumaric acid, mesaconic acid, citraconic acid, terephthalic acid, cyclohexane dicarboxylic acid, succinic acid, adipic acid, sebacic acid, malonic acid, divalent organic acids in which the above compounds are substituted with a saturated or unsaturated hydrocarbon group having 3 to 22 carbon atoms, anhydrides and lower esters of the above compounds, dimer acids of linoleic acid, and tri- or more valent carboxylic acids (e.g., 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid enpol trimmer acid, and anhydrides of these compounds).

When a crystalline polyester resin is used together, the toner is fixable at low temperature and improve glossiness of images even at low temperature. The crystalline polyester resin transforms its crystal at a glass transition temperature, and quickly decreases melt viscosity from solid state to be fixable on recording media such as papers.

The crystalline polyester resin preferably has a crystalline index, i.e., a ratio of a softening point to an endothermic maximum peak temperature measure by a differential scanning calorimeter (DSC), of from 0.6 to 1.5, and more preferably from 0.8 to 1.2. The content of the crystalline polyester resin is preferably from 1 to 35 parts by weight, and preferably from 1 to 25 parts by weight per 100 parts by weight of the polyester resin. When too much, toner filming over image bearers such as a photoreceptor tends to occur and storage stability of the toner deteriorates.

The epoxy resin can be obtained from polycondensing between bisphenol A and epichlorohydrin. Specific examples of commercially available epoxy resins include, but are not limited to, EPOMIK R362, R364, R365, R366, R367, and R369 (from Mitsui Chemicals, Inc.), EPOTOHTO YD-011, YD-012, YD-014, YD-904, and YD-017, (from Nippon Steel Chemical Co., Ltd.), and EPIKOTE 1002, 1004, and 1007 (from Shell Chemicals).

Specific examples of usable colorants include, but are not limited to, carbon black, lamp black, iron black, Ultramarine Blue, Nigrosine dyes, Aniline Blue, Phthalocyanine Blue, Hansa Yellow G, Rhodamine 6G Lake, Calco Oil Blue, Chrome Yellow, Quinacridone, Benzidine Yellow, Rose Bengal, triarylmethane dyes, monoazo and disazo dyes and pigments. Two or more of such colorants can be used in combination to obtain a desired color tone.

A transparent toner can be formed without a colorant.

Black toner may include a magnetic material to be used as a magnetic toner. Specific examples of usable magnetic materials include, but are not limited to, powders of ferromagnetic materials (e.g., iron, cobalt), magnetite, hematite, Li ferrite, Mn—Zn ferrite, Cu—Zn ferrite, Ni—Zn ferrite, and Ba ferrite.

The toner may include a charge controlling agent to improve frictional chargeability. Specific examples of usable charge controlling agents include, but are not limited to, metal complex salts of monoazo dyes, nitrohumic acid and salts thereof, metal complex of salicylic acid, naphthoic acid, and dicarboxylic acid with Co, Cr, Ce, etc., amino compounds, quaternary ammonium compounds, and organic dyes.

Preferably, the toners having colors other than black include a white or a transparent material such as a white metal salt of a salicylic acid derivative.

The toner may include a release agent. Specific examples of usable release agents include, but are not limited to, low-molecular-weight polypropylene, low-molecular-weight polyethylene, carnauba wax, microcrystalline wax, jojoba wax, rice wax, montan wax. Two or more of these release agents can be used in combination.

The toner may externally include a fluidizer. The toner having proper fluidity produces high quality images. For example, fine particles of hydrophobized metal oxides, lubricants, metal oxides, organic resins, and metal salts may be externally added to the toner. Specific examples of suitable fluidizers include, but are not limited to, lubricants such as fluorocarbon resins (e.g., polytetrafluoroethylene) and zinc stearate; abrasive agents such cerium oxide and silicon carbide; inorganic oxides such as SiO₂ and TiO₂, the surfaces of which may be hydrophobized; caking preventing agents; and the above compounds of which surfaces are treated. Among various compounds, hydrophobized silica is preferable as a fluidizer.

The toner preferably has a weight average particle diameter of 3.0 to 9.0 μm, and more preferably 3.0 to 6.0 μm.

Particle diameter of the toner can be measured by COULTER MULTISIZER II (from Beckman Coulter, Inc.).

A weight-average particle diameter Dw of the carrier, core material and toner can be determined by the following formula (1):

Dw={1/Σ(nD²)}×{E(nD⁴)} (1)

wherein D represents a representative diameter (μm) present in each channel and n represents a total number of particles present therein.

The channel is a length equally dividing a scope of particle diameters in the particle diameter distribution, and the length is 2 μm for the carrier of the present invention. The representative diameter present in each channel is a minimum particle diameter of the particles present in each channel.

In addition, the number-average particle diameter Dp of the carrier or the core material thereof is determined according to the particle diameter distribution measured on a number standard. The number-average particle diameter Dp can be determined by the following formula (III):

Dp={1/N}×{ΣnD} (2)

wherein N represents a total number of particles measured, n represents a total number of particles present in each channel and D represents a minimum particle diameter of the particles present in each channel (2 μm).

In the present invention, the measurement was performed by the following measurers after the toner and carrier were suctioned or air blown through mesh to be separated from each other.

### [Particle Diameter Distribution]

A particle size analyzer Microtrac HRA 9320-X100 from Honeywell, Inc. was used to measure a particle diameter distribution of the carrier under the following conditions:

(1) Scope of particle diameter: 100 to 8 μm

(2) Channel length (width): 2 μm

(3) Number of channels: 46

(4) Refraction index: 2.42

### [Bulk Density]

The bulk density was measured by a bulk densitometer (from TSUTSUI SCIENTIFIC INSTRUMENTS Co., LTD.) according to a metallic powder apparent density test method JIS-Z2504.

### [Magnetization]

After about 0.15 g of the carrier were filled in a cell having an inner diameter of 2.4 mm and a height of 8.5 mm, the magnetization was measured by VSM-P7-15 type from Toei Industrial Co., Ltd. in a magnetic field of 5 kOe.

### [BET Specific Surface Area]

BET specific surface area of 5.0 g of the carrier was measured by Tristar 3000 from Shimadzu Corp.

The carrier may be used for a supplemental developer that is supplied to a developing device while a deteriorated developer is discharged therefrom. Because deteriorated carrier particles are replaced with fresh carrier particles included in the supplemental developer, toner particles are reliably charged and images are stably produced for an extended period of time.

The use of supplemental developer is effective when printing an image having a high area occupancy. When printing an image having a high area occupancy, carrier particles are deteriorated by adherence of toner particles while a large amount of supplemental carrier particles are supplied. Thus, the frequency of replacing deteriorated carrier particles with fresh carrier particles is increased and images are stably produced for an extended period of time.

The supplemental developer preferably includes a toner in an amount of 2 to 50 parts by weight, more preferably 5 to 12 parts by weight, based on 1 part by weight of the carrier.

When the amount of toner is too small, toner particles may be excessively charged because an excessive amount of the carrier particles exist in a developing device. Because the excessively charged toner particles have poor developing power, the resulting image density may deteriorate. When the amount of toner is too large, the frequency of replacing deteriorated carrier particles with fresh carrier particles is reduced.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

FIG. 1 is a cross-sectional view illustrating an image developer included in an image forming method according to exemplary aspects of the invention.

A developing device 40 is provided facing a photoreceptor drum 20 serving as an image bearing member. The developing device 40 includes a developing sleeve 41 serving as a developer bearing member, a developer container 42, a doctor blade 43 serving as a regulation member, and a support casing 44.

The support casing 44 has an opening on a side facing the photoreceptor drum 20. A toner hopper 45 serving as a toner container that contains toner particles 21 is attached to the support casing 44. A developer containing part 46 contains a developer comprising the toner particles 21 and carrier particles 23. A developer agitator 47 agitates the toner particles 21 and carrier particles 23 to frictionally charge the toner particles 21.

A toner agitator 48 and a toner supplying mechanism 49 each rotated by riving means, not shown, are provided in the toner hopper 45. The toner agitator 48 and the toner supplying mechanism 49 agitate and supply the toner particles 21 in the toner hopper 45 toward the developer containing part 46.

The developing sleeve 41 is provided within a space between the photoreceptor drum 20 and the toner hopper 45. The developing sleeve 41 is driven to rotate counterclockwise in FIG. 1 by a driving means, not shown. The developing sleeve 41 internally contains a magnet serving as a magnetic field generator. The relative position of the magnet to the developing device 40 remains unchanged.

The doctor blade 43 is integrally provided to the developer container 42 on the opposite side of the support casing 44. A constant gap is formed between the tip of the doctor blade 43 and the circumferential surface of the developing sleeve 41.

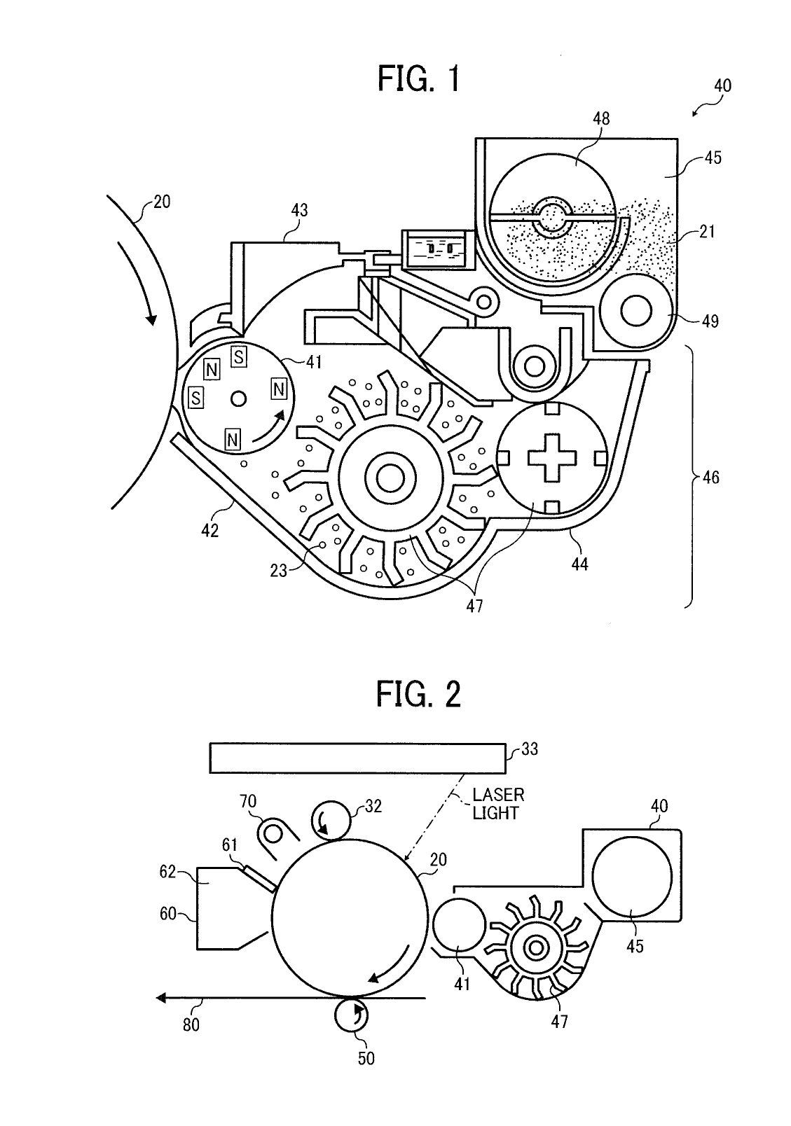

In a developing method according to exemplary aspects of the invention, the toner agitator 48 and the toner supplying mechanism 49 feed the toner particles 21 from the toner hopper 45 to the developer containing part 46. The developer agitator 47 agitates the toner particles 21 and the carrier particles 23 to frictionally charge the toner particles 21. The developing sleeve 41 bears the charged toner particles 21 and conveys them to a position where faces an outer peripheral surface of the photoreceptor drum 20 by rotation. The toner particles 21 then electrostatically bind to an electrostatic latent image formed on the photoreceptor drum 20. Thus, a toner image is formed on the photoreceptor drum 20. FIG. 2 is a schematic view illustrating an embodiment of image forming apparatus executing the image forming method of the present invention.

Around a photoreceptor drum 20, a charging member 32, an irradiator 33, a developing device 40, a transfer member 50, a cleaning device 60, and a neutralization lamp 70 are provided. A surface of the charging member 32 forms a gap of about 0.2 mm with a surface of the photoreceptor 20. When an electric filed in which an alternating current component is overlapped with a direct current component is applied to the charging member 32 from a voltage applying mechanism, not shown, the photoreceptor 20 can be uniformly charged.

This image forming apparatus employs a negative-positive image forming process. The photoreceptor 20 having an organic photoconductive layer is neutralized by the neutralization lamp 70, and then negatively charged by the charging member 32. The charged photoreceptor 20 is irradiated with a laser light beam emitted from the irradiator 33 to form an electrostatic latent image thereon. In this embodiment, the absolute value of the potential of the irradiated portion is lower than that of the non-irradiated portion.

The laser light beam is emitted from a semiconductive laser. A polygon mirror that is a polygonal column rotating at a high speed scans the surface of the photoreceptor 20 with the laser light beam in the axial direction. The electrostatic latent image thus formed is then developed into a toner image with a developer supplied to a developing sleeve 41 in the developing device 40. When developing electrostatic latent image, a developing bias that is a predetermined voltage or that overlapped with an alternating current voltage is applied from a voltage applying mechanism, not shown, to between the developing sleeve 41 and the irradiated and non-irradiated portions on the photoreceptor 20.

On the other hand, a transfer medium 80 (e.g., paper, an intermediate transfer medium) is fed from a paper feed mechanism, not shown. A pair of registration rollers, not shown, feeds the transfer medium 80 to a gap between the photoreceptor 20 and the transfer member 50 in synchronization with an entry of the toner image to the gap so that the toner image is transferred onto the transfer medium 80. When transferring toner image, a transfer bias that is a voltage having the opposite polarity to the toner charge is applied to the transfer member 50. Thereafter, the transfer medium 80 separates from the photoreceptor 20.

Toner particles remaining on the photoreceptor 20 are removed by a cleaning blade 61 and collected in a toner collection chamber 62 in the cleaning device 60.

The collected toner particles may be refed to the developing device 40 by a recycle mechanism, not shown.

The image forming apparatus may include multiple developing devices. In this case, multiple toner images are sequentially transferred onto a transfer medium to form a composite toner image, and the composite toner image is finally fixed on the transfer medium. The image forming apparatus may further include and an intermediate transfer member. In this case, multiple toner images are transferred onto the intermediate transfer member to form a composite toner image, and the composite toner image is then transferred onto and fixed on a transfer medium.

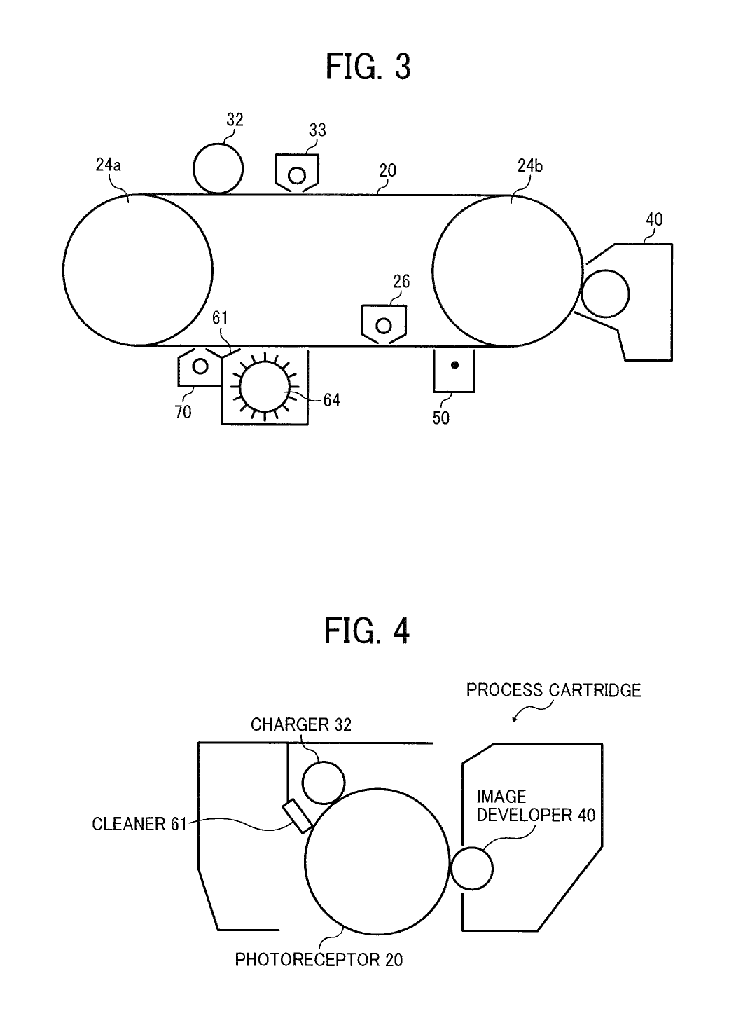

FIG. 3 is a schematic view illustrating another embodiment of image forming apparatus executing the image forming method of the present invention. A photoreceptor 20 having a conductive substrate and a photosensitive layer is driven by driving rollers 24a and 24b. The photoreceptor 20 is repeatedly subjected to processes of charging by a charging member 32, irradiation by an irradiator, development by a developing device 40, transfer by a transfer member 50, pre-cleaning irradiation by a light source 26, cleaning by a cleaning brush 64 and a cleaning blade 61, and neutralization by a neutralization lamp 70. In the pre-cleaning irradiation process, light is emitted from the back side of the photoreceptor 20. Therefore, in this embodiment, the conductive substrate is translucent.

FIG. 4 is a schematic view illustrating an embodiment of process cartridge of the present invention. The process cartridge integrally supports a photoreceptor 20, a charging member 32, a developing device 40, and a cleaning blade 61. The process cartridge is detachably attachable to image forming apparatuses.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### (Core Material Preparation Method 1)

MnCO₃ and Fe₂O₃ were mixed at a weight ratio (MnCO₃/Fe₂O₃) of 35/65 to prepare a mixed powder. As a volatile component, 25 parts of SiO₂ were added to 100 parts of the mixed powder, and a dispersant, a binder resin, a defoamer and water were added thereto and mixed to prepare a slurry having a solid content concentration of 60%.

The slurry was centrifugally sprayed to prepare a granulated material having a particle diameter of from 10 to 200 μm. The granulated material was classified into those having an average particle diameter of 40 and burned at 1,250° C. for 6 hrs in a nitrogen atmosphere to prepare a burned material.

The burned material was pulverized by a pulverizer and sifted to prepare a spherical particulate material having a volume-average particle diameter about 35 μm.

The surface of the spherical particulate material was oxidized at 400° C. for 3 hrs to prepare a [spherical ferrite core material 1].

The [spherical ferrite core material 1] had a bulk density of 1.84 g/cm³, a saturated magnetization σ5000 of 78 emu/g when measured at 5 kOe, a residual magnetization σr of 0.3 emu/g and a BET specific surface area of 0.18 m³/g.

### (Core Material Preparation Method 2)

The procedure for preparation of the [spherical ferrite core material 1] was repeated except for changing the parts of SiO₂ from 25 to 20 parts by weight to prepare a [spherical ferrite core material 2].

The [spherical ferrite core material 2] had a bulk density of 2.01 g/cm³, a saturated magnetization σ5000 of 78 emu/g when measured at 5 kOe, a residual magnetization σr of 1.0 emu/g and a BET specific surface area of 0.15 m³/g.

### (Core Material Preparation Method 3)

The procedure for preparation of the [spherical ferrite core material 1] was repeated except for changing the parts of SiO₂ from 25 to 15 parts by weight to prepare a [spherical ferrite core material 3].

The [spherical ferrite core material 3] had a bulk density of 2.08 g/cm³, a saturated magnetization σ5000 of 78 emu/g when measured at 5 kOe, a residual magnetization σr of 1.2 emu/g and a BET specific surface area of 0.13 m³/g.

### (Core Material Preparation Method 4)

MnCO₃ and Fe₂O₃ were mixed at a weight ratio (MnCO₃/Fe₂O₃) of 35/65 to prepare a mixed powder. As a volatile component, 35 parts of SiO₂ were added to 100 parts of the mixed powder, and a dispersant, a binder resin, a defoamer and water were added thereto and mixed to prepare a slurry having a solid content concentration of 60%.

The slurry was centrifugally sprayed to prepare a granulated material having a particle diameter of from 10 to 200 μm. The granulated material was classified into those having an average particle diameter of 60 μm, and burned at 1,250° C. for 6 hrs in a nitrogen atmosphere to prepare a burned material.

The burned material was pulverized by a pulverizer and sifted to prepare a spherical particulate material having a volume-average particle diameter about 50 μm.

The surface of the spherical particulate material was oxidized at 400° C. for 3 hrs to prepare a [spherical ferrite core material 4].

The [spherical ferrite core material 4] had a bulk density of 1.55 g/cm³, a saturated magnetization σ5000 of 78 emu/g when measured at 5 kOe, a residual magnetization σr of 0.7 emu/g and a BET specific surface area of 0.09 m³/g.

### (Core Material Preparation Method 5)

The procedure for preparation of the [spherical ferrite core material 4] was repeated except for changing the parts of SiO₂ from 35 to 40 parts by weight to prepare a [spherical ferrite core material 5].

The [spherical ferrite core material 5] had a bulk density of 1.47 g/cm³, a saturated magnetization σ5000 of 78 emu/g when measured at 5 kOe, a residual magnetization σr of 0.6 emu/g and a BET specific surface area of 0.11 m³/g.

### (Core Material Preparation Method 6)

The procedure for preparation of the [spherical ferrite core material 1] was repeated except for not adding a volatile component to prepare a [spherical ferrite core material 6].

The [spherical ferrite core material 6] had a bulk density of 2.40 g/cm³, a saturated magnetization σ5000 of 79 emu/g when measured at 5 kOe, a residual magnetization σr of 0.3 emu/g and a BET specific surface area of 0.07 m³/g.

### (Core Material Preparation Method 7)

A mixture of MnCO₃, Mg(OH)₂, Fe₂O₃ and SrCO₃ were pre-burnt at 850° C. for 1 hr in the atmosphere using a heating oven, followed by cooling and pulverization to prepare a powder having a particle diameter not greater than 3 μm.

A dispersant, a binder resin, a defoamer and water were added to the powder and mixed to prepare a slurry having a solid content concentration of 60%.

The slurry was centrifugally sprayed to prepare a granulated material having a particle diameter of from 10 to 200 μm. The granulated material was classified into those having an average particle diameter of 40 μm, and burned at 1,200° C. for 6 hrs in a nitrogen atmosphere to prepare a burned material.

The burned material was pulverized by a pulverizer and sifted to prepare a spherical particulate material having a volume-average particle diameter about 35 μm.

The surface of the spherical particulate material was oxidized at 400° C. for 3 hrs to prepare a [spherical ferrite core material 7].

The [spherical ferrite core material 7] included MnO of 40.0%, MgO of 10.0%, Fe₂O₃ of 50.0% and SrO of 0.4% by mol, respectively.

The [spherical ferrite core material 7] had a bulk density of 1.94 g/cm³, a saturated magnetization σ5000 of 69 emu/g when measured at 5 kOe, a residual magnetization σr of 0.7 emu/g and a BET specific surface area of 0.22 m³/g.

### (Core Material Preparation Method 8)

The procedure for preparation of the [spherical ferrite core material 7] was repeated except for burning the granulated material at 1,250° C. instead of 1,200° C. to prepare a [spherical ferrite core material 8].

The [spherical ferrite core material 8] had a bulk density of 2.10 g/cm³, a saturated magnetization σ5000 of 69 emu/g when measured at 5 kOe, a residual magnetization σr of 0.6 emu/g and a BET specific surface area of 0.15 m³/g.

### (Core Material Preparation Method 9)

A marketed resin carrier formed of magnetite and a phenol resin (MRC101 from TODA KOGYO CORP.) was prepared as a [spherical ferrite core material 9].

The [spherical ferrite core material 9] had a bulk density of 1.90 g/cm³, a saturated magnetization σ5000 of 73 emu/g when measured at 5 kOe, a residual magnetization σr of 5.2 emu/g and a BET specific surface area of 0.07 m³/g.

### Electroconductive Particulate Material Preparation Example 1

A suspension was prepared by dispersing 100 g of aluminum oxide (AKP-30 from Sumitomo Chemical Co., Ltd.) in 1 liter of water, followed by heating at 70° C. A solution in which 150 g of tin tetrachloride and 4.5 g of phosphorus pentoxide were dissolved in 1.5 liters of 2N hydrochloric acid and a 12% ammonia water were dropped in the suspension over a period of 3 hours so that pH of the suspension becomes 7 to 8. The suspension was then filtered and washed to obtain a cake. The cake was dried at 110° C.

Next, the resultant dried powder was treated at 500° C. for 1 hour under nitrogen stream to prepare an [electroconductive particulate material 1].

The [electroconductive particulate material 1] had an average particle diameter of 600 nm and a specific volume resistivity of 3 Ω·cm.

### Electroconductive Particulate Material Preparation Example 2

A suspension was prepared by dispersing 100 g of aluminum oxide (AKP-30 from Sumitomo Chemical Co., Ltd.) in 1 liter of water, followed by heating at 70° C. A solution in which 11.6 g of tin tetrachloride were dissolved in 1 liter of 2N hydrochloric acid and a 12% ammonia water were dropped in the suspension over a period of 40 min so that pH of the suspension becomes 7 to 8.

Further, a solution in which 36.7 g of indium chloride and 5.4 g of tin tetrachloride were dissolved in 450 33 liter of 2N hydrochloric acid and a 12% ammonia water were dropped in the suspension over a period of 1 hr so that pH of the suspension becomes 7 to 8. The suspension was then filtered and washed to obtain a cake. The cake was dried at 110° C.

Next, the resultant dried powder was treated at 500° C. for 1 hour under nitrogen stream to prepare an [electroconductive particulate material 2].

The [electroconductive particulate material 2] had an average particle diameter of 300 nm and a specific volume resistivity of 4 Ω·cm.

### Resin Synthesis Example 1

Three hundred (300) g of toluene were placed in a flask including a stirrer, and heated to have a temperature of 90° C. under nitrogen stream. Next, a mixture of 84.4 g (200 mmol) of 3-methacryloxypropyltris(trimethylsiloxy)silane having a formula of CH₂═CMe-COO—C₃H₆—Si(OSiMe₃)₃ (Me is a methyl group) Silaplane TM-0701T (manufactured by Chisso Corporation), 39 g (150 mmol) of 3-methacryloxypropyltrimethoxysilane, 65.0 g (650 mmol) of methylmethacrylate and 0.58 g (3 mmol) of 2,2′-azobis-2-methylbutyronitrile was dropped therein for 1 hour. Further, a solution in which 0.06 g (0.3 mmol) of 2,2′-azobis-2-methylbutyronitrile was dissolved in 15 g of toluene was added (total 0.64 g=3.3 mmol of, 2′-azobis-2-methylbutyronitrile), then, mixed at 90 to 100° C. for 3 hours such that radical copolymerization is performed to prepare a [methacrylic copolymer].

The methacrylic copolymer had a weight-average molecular weight of 33,000. A solution of the methacrylic copolymer 1 was diluted with toluene to have a nonvolatile component of 25% by weight. The copolymer solution had a viscosity of 8.8 mm²/sec and a specific gravity of 0.91.

### Carrier Preparation Example 1

One hundred and eight (108) parts of methyl silicone resin (silicone resin having a silanol group and/or a hydrolyzable functional group) formed from a di- or trifunctional monomer having a weight-average molecular weight of 15,000 and a solid content of 25%, 27 parts of the [methacrylic copolymer] prepared in Resin Synthesis Example 1 (solid content of 25%), 20 parts of the [electroconductive particulate material 1], 7 parts of TC-750 from Matsumoto Fine Chemical Co., Ltd. that is titanium diisopropoxybis(ethyl acetoacetate) as a catalyst, and 1 part of a silane coupling agent SH6020 from Dow Corning Toray Silicone Co., Ltd. were diluted in toluene to prepare a [resin solution 1] including a solid content of 10% by weight.

The [resin solution 1] was coated on 1000 parts of the [spherical ferrite core material 1] using a fluidized-bed coater while the fluid tank had an inner temperature of 70° C., and dried to prepare a carrier. The carrier was burnt in an electric oven at 180° C. for 2 hrs to prepare a [carrier A].

The [carrier A] had a bulk density of 1.95 g/cm³, a BET specific surface area of 0.9 m³/g, a saturated magnetization σ5000 of 74 emu/g when measured at 5 kOe and a residual magnetization σr of 0.3 emu/g.

### Carrier Preparation Example 2

Thirty (30) parts of methyl silicone resin formed from a di- or trifunctional monomer having a weight-average molecular weight of 15,000 and a solid content of 25%, 10 parts of the [methacrylic copolymer] prepared in Resin Synthesis Example 1 (solid content of 25%), 30 parts of the [electroconductive particulate material 2], 2 parts of TC-750 from Matsumoto Fine Chemical Co., Ltd. that is titanium diisopropoxybis(ethyl acetoacetate) as a catalyst, and 0.3 parts of a silane coupling agent SH6020 from Dow Corning Toray Silicone Co., Ltd. were diluted in toluene to prepare a [resin solution 2] including a solid content of 10% by weight.

The [resin solution 2] was coated on 1000 parts of the [spherical ferrite core material 2] using a fluidized-bed coater while the fluid tank had an inner temperature of 70° C., and dried to prepare a carrier. The carrier was burnt in an electric oven at 180° C. for 2 hrs to prepare a [carrier B].

The [carrier B] had a bulk density of 2.06 g/cm³, a BET specific surface area of 0.6 m³/g, a saturated magnetization σ5000 of 74 emu/g when measured at 5 kOe and a residual magnetization σr of 1.0 emu/g.

### Carrier Preparation Example 3

One hundred and eight (108) parts of methyl silicone resin formed from a di- or trifunctional monomer having a weight-average molecular weight of 15,000 and a solid content of 25%, 27 parts of the [methacrylic copolymer] prepared in Resin Synthesis Example 1 (solid content of 25%), 120 parts of the [electroconductive particulate material 1], 7 parts of TC-750 from Matsumoto Fine Chemical Co., Ltd. that is titanium diisopropoxybis(ethyl acetoacetate) as a catalyst, and 1 part of a silane coupling agent SH6020 from Dow Corning Toray Silicone Co., Ltd. were diluted in toluene to prepare a [resin solution 3] including a solid content of 10% by weight.

The [resin solution 3] was coated on 1000 parts of the [spherical ferrite core material 2] using a fluidized-bed coater while the fluid tank had an inner temperature of 70° C., and dried to prepare a carrier. The carrier was burnt in an electric oven at 180° C. for 2 hrs to prepare a [carrier C].

The [carrier C] had a bulk density of 2.15 g/cm³, a BET specific surface area of 1.0 m³/g, a saturated magnetization σ5000 of 73 emu/g when measured at 5 kOe and a residual magnetization σr of 1.0 emu/g.

### Carrier Preparation Example 4

One hundred and seventy seven (177) parts of methyl silicone resin formed from a di- or trifunctional monomer having a weight-average molecular weight of 15,000 and a solid content of 25%, 118 parts of the [methacrylic copolymer] prepared in Resin Synthesis Example 1 (solid content of 25%), 80 parts of the [electroconductive particulate material 1], parts of TC-750 from Matsumoto Fine Chemical Co., Ltd. that is titanium diisopropoxybis(ethyl acetoacetate) as a catalyst, and 1 part of a silane coupling agent SH6020 from Dow Corning Toray Silicone Co., Ltd. were diluted in toluene to prepare a [resin solution 4] including a solid content of 10% by weight.

The [resin solution 4] was coated on 1000 parts of the [spherical ferrite core material 2] using a fluidized-bed coater while the fluid tank had an inner temperature of 70° C., and dried to prepare a carrier. The carrier was burnt in an electric oven at 180° C. for 2 hrs to prepare a [carrier D].

The [carrier D] had a bulk density of 2.18 g/cm³, a BET specific surface area of 1.8 m³/g, a saturated magnetization σ5000 of 72 emu/g when measured at 5 kOe and a residual magnetization σr of 0.9 emu/g.

### Carrier Preparation Example 5

One hundred and thirty five (135) parts of methyl silicone resin formed from a di- or trifunctional monomer having a weight-average molecular weight of 15,000 and a solid content of 25%, 40 parts of the [electroconductive particulate material 1], 7 parts of TC-750 from Matsumoto Fine Chemical Co., Ltd. that is titanium diisopropoxybis(ethyl acetoacetate) as a catalyst, and 1 part of a silane coupling agent SH6020 from Dow Corning Toray Silicone Co., Ltd. were diluted in toluene to prepare a [resin solution 5] including a solid content of 10% by weight.

The [resin solution 5] was coated on 1000 parts of the [spherical ferrite core material 3] using a fluidized-bed coater while the fluid tank had an inner temperature of 70° C., and dried to prepare a carrier. The carrier was burnt in an electric oven at 180° C. for 2 hrs to prepare a [carrier E].

The [carrier E] had a bulk density of 2.18 g/cm³, a BET specific surface area of 1.1

M³/g, a saturated magnetization σ5000 of 75 emu/g when measured at 5 kOe and a residual magnetization σr of 1.2 emu/g.

### Carrier Preparation Comparative Example 1

One hundred and ten (110) parts of methyl silicone resin formed from a di- or trifunctional monomer having a weight-average molecular weight of 15,000 and a solid content of 25%, 110 parts of the [methacrylic copolymer] prepared in Resin Synthesis Example 1 (solid content of 25%), 200 parts of the [electroconductive particulate material 1], 11 parts of TC-750 from Matsumoto Fine Chemical Co., Ltd. that is titanium diisopropoxybis(ethyl acetoacetate) as a catalyst, and 1.8 parts of a silane coupling agent SH6020 from Dow Corning Toray Silicone Co., Ltd. were diluted in toluene to prepare a [resin solution 6] including a solid content of 10% by weight.

The [resin solution 6] was coated on 1000 parts of the [spherical ferrite core material 3] using a fluidized-bed coater while the fluid tank had an inner temperature of 70° C., and dried to prepare a carrier. The carrier was burnt in an electric oven at 180° C. for 2 hrs to prepare a [carrier F].

The [carrier F] had a bulk density of 2.27 g/cm³, a BET specific surface area of 1.5 m³/g, a saturated magnetization σ5000 of 75 emu/g when measured at 5 kOe and a residual magnetization σr of 1.2 emu/g.

### Carrier Preparation Example 6

Eighty (80) parts of methyl silicone resin formed from a di- or trifunctional monomer having a weight-average molecular weight of 15,000 and a solid content of 25%, 20 parts of the [methacrylic copolymer] prepared in Resin Synthesis Example 1 (solid content of 25%), 40 parts of the [electroconductive particulate material 2], 5 parts of TC-750 from Matsumoto Fine Chemical Co., Ltd. that is titanium diisopropoxybis(ethyl acetoacetate) as a catalyst, and 0.8 parts of a silane coupling agent SH6020 from Dow Corning Toray Silicone Co., Ltd. were diluted in toluene to prepare a [resin solution 7] including a solid content of 10% by weight.

The [resin solution 7] was coated on 1000 parts of the [spherical ferrite core material 4] using a fluidized-bed coater while the fluid tank had an inner temperature of 70° C., and dried to prepare a carrier. The carrier was burnt in an electric oven at 180° C. for 2 hrs to prepare a [carrier G].

The [carrier G] had a bulk density of 1.68 g/cm³, a BET specific surface area of 0.8 m³/g, a saturated magnetization σ5000 of 74 emu/g when measured at 5 kOe and a residual magnetization σr of 0.7 emu/g.

### Carrier Preparation Comparative Example 2

The procedure for preparation of the [carrier G] was repeated except for coating the [resin solution 7] on 1000 parts of the [spherical ferrite core material 5] instead of the [spherical ferrite core material 4] to prepare a [carrier H].

The [carrier H] had a bulk density of 1.58 g/cm³, a BET specific surface area of 0.8 m³/g, a saturated magnetization σ5000 of 74 emu/g when measured at 5 kOe and a residual magnetization σr of 0.6 emu/g.

### Carrier Preparation Comparative Example 3

One hundred and thirty five (135) parts of methyl silicone resin formed from a di- or trifunctional monomer having a weight-average molecular weight of 15,000 and a solid content of 25%, 27 parts of the [methacrylic copolymer] prepared in Resin Synthesis Example 1 (solid content of 25%), 30 parts of the [electroconductive particulate material 2], 7 parts of TC-750 from Matsumoto Fine Chemical Co., Ltd. that is titanium diisopropoxybis(ethyl acetoacetate) as a catalyst, and 1 part of a silane coupling agent SH6020 from Dow Corning Toray Silicone Co., Ltd. were diluted in toluene to prepare a [resin solution 8] including a solid content of 10% by weight.

The [resin solution 8] was coated on 1000 parts of the [spherical ferrite core material 6] using a fluidized-bed coater while the fluid tank had an inner temperature of 70° C., and dried to prepare a carrier. The carrier was burnt in an electric oven at 180° C. for 2 hrs to prepare a [carrier I].

The [carrier I] had a bulk density of 2.47 g/cm³, a BET specific surface area of 0.7 m³/g, a saturated magnetization σ5000 of 76 emu/g when measured at 5 kOe and a residual magnetization σr of 0.3 emu/g.

### Carrier Preparation Comparative Example 4

The procedure for preparation of the [carrier I] was repeated except for coating the [resin solution 8] on 1000 parts of the [spherical ferrite core material 7] instead of the [spherical ferrite core material 6] to prepare a [carrier J].

The [carrier J] had a bulk density of 2.10 g/cm³, a BET specific surface area of 1.1 m³/g, a saturated magnetization σ5000 of 65 emu/g when measured at 5 kOe and a residual magnetization σr of 0.7 emu/g.

### Carrier Preparation Comparative Example 5

The procedure for preparation of the [carrier J] was repeated except for coating the [resin solution 8] on 1000 parts of the [spherical ferrite core material 8] instead of the [spherical ferrite core material 7] to prepare a [carrier K].

The [carrier K] had a bulk density of 2.22 g/cm³, a BET specific surface area of 1.0 m³/g, a saturated magnetization σ5000 of 65 emu/g when measured at 5 kOe and a residual magnetization σr of 0.6 emu/g.

### Carrier Preparation Comparative Example 6

The procedure for preparation of the [carrier I] was repeated except for coating the [resin solution 8] on 1000 parts of the [spherical ferrite core material 9] instead of the [spherical ferrite core material 6] and burning the carrier at 130° C. instead of 180° C. for 2 hrs to prepare a [carrier L].

The [carrier L] had a bulk density of 2.10 g/cm³, a BET specific surface area of 0.7 m³/g, a saturated magnetization σ5000 of 67 emu/g when measured at 5 kOe and a residual magnetization σr of 6.3 emu/g.

### Carrier Preparation Comparative Example 7

Fifteen (15) parts of methyl silicone resin formed from a di- or trifunctional monomer having a weight-average molecular weight of 15,000 and a solid content of 25%, 10 parts of the [methacrylic copolymer] prepared in Resin Synthesis Example 1 (solid content of 25%), 20 parts of the [electroconductive particulate material 1], 1 part of TC-750 from Matsumoto Fine Chemical Co., Ltd. that is titanium diisopropoxybis(ethyl acetoacetate) as a catalyst, and 0.2 parts of a silane coupling agent SH6020 from Dow Corning Toray Silicone Co., Ltd. were diluted in toluene to prepare a [resin solution 9] including a solid content of 10% by weight.

The [resin solution 9] was coated on 1000 parts of the [spherical ferrite core material 2] using a fluidized-bed coater while the fluid tank had an inner temperature of 70° C., and dried to prepare a carrier. The carrier was burnt in an electric oven at 180° C. for 2 hrs to prepare a [carrier M].

The [carrier M] had a bulk density of 2.04 g/cm³, a BET specific surface area of 0.4 m³/g, a saturated magnetization σ5000 of 75 emu/g when measured at 5 kOe and a residual magnetization σr of 1.0 emu/g.

### Carrier Preparation Comparative Example 8

Three hundred (300) parts of methyl silicone resin formed from a di- or trifunctional monomer having a weight-average molecular weight of 15,000 and a solid content of 25%, 105 parts of the [methacrylic copolymer] prepared in Resin Synthesis Example 1 (solid content of 25%), 90 parts of the [electroconductive particulate material 1], 21 parts of TC-750 from Matsumoto Fine Chemical Co., Ltd. that is titanium diisopropoxybis(ethyl acetoacetate) as a catalyst, and 3 parts of a silane coupling agent SH6020 from Dow Corning Toray Silicone Co., Ltd. were diluted in toluene to prepare a [resin solution 10] including a solid content of 10% by weight.

The [resin solution 10] was coated on 1000 parts of the [spherical ferrite core material 2] using a fluidized-bed coater while the fluid tank had an inner temperature of 70° C., and dried to prepare a carrier. The carrier was burnt in an electric oven at 180° C. for 2 hrs to prepare a [carrier N].

The [carrier N] had a bulk density of 2.24 g/cm³, a BET specific surface area of 2.1 m³/g, a saturated magnetization σ5000 of 70 emu/g when measured at 5 kOe and a residual magnetization σr of 1.0 emu/g.

TABLE 1

| RS | MSR | MC | EPM 1 | EPM 2 | Catalyst | SCA |
|---|---|---|---|---|---|---|
| 1 | 108 | 27 | 20 | | 7 | 1 |
| 2 | 30 | 10 | | 30 | 2 | 0.3 |
| 3 | 108 | 27 | 120 | | 7 | 1 |
| 4 | 177 | 118 | 80 | | 15 | 1 |
| 5 | 135 | | 40 | | 7 | 1 |
| 6 | 110 | 110 | 200 | | 11 | 1.8 |
| 7 | 80 | 20 | | 40 | 5 | 0.8 |
| 8 | 135 | 27 | | 30 | 7 | 1 |
| 9 | 15 | 10 | 20 | | 1 | 0.2 |
| 10 | 300 | 105 | 90 | | 21 | 3 |

RS: Resin Solution
MSR: Methyl Silicone Resin
MC: Methacrylic Copolymer
EPM: Electroconductive Particulate Material
SCA: Silane Coupling Agent

### <Preparation of Developer>

Each of the carriers A to N was stirred with a toner by a tubular mixer at 81 rpm for 5 min to prepare a developer for evaluation having a toner concentration of 7%.

A supplemental developer including the carrier in an amount of 10% by weight was prepared.

### <Evaluation Method>

Using a marketed digital full-color printer RICOH Pro C901 from Ricoh Company, Ltd., ghost images and carrier adherence were evaluated with the developer for evaluation, and then after 100,000 images having an image density of 8% were produced, ghost images, carrier adherence and resistivity variation were evaluated.

### <Ghost Image Evaluation>

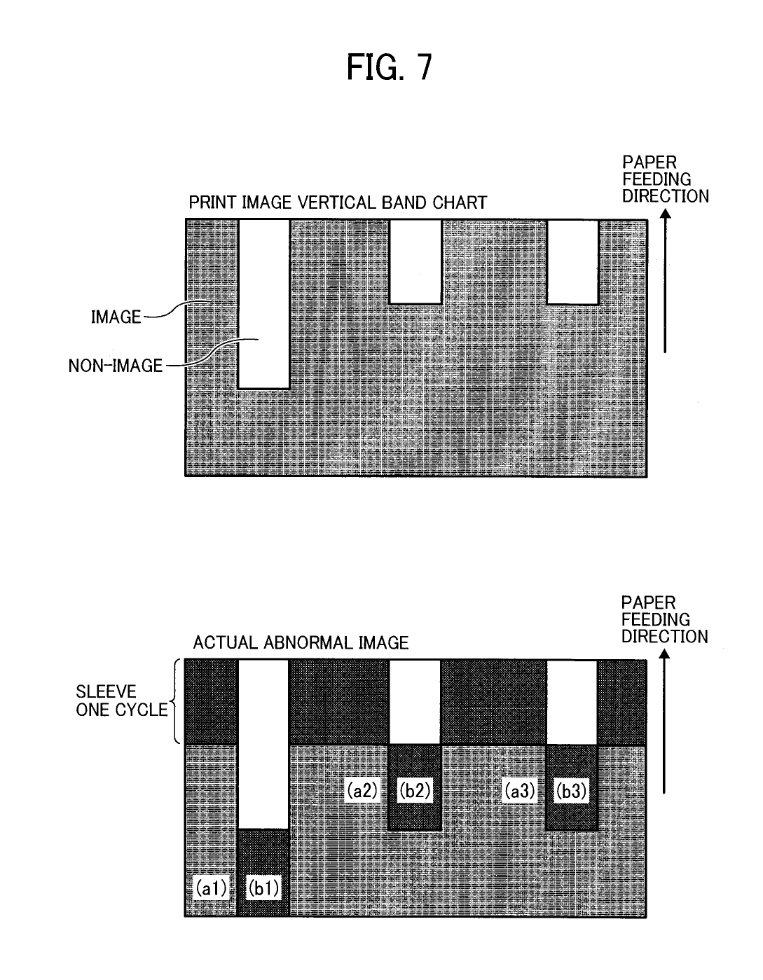

Each of the developers was set in a marketed digital full-color printer RICOH Pro C901 from Ricoh Company, Ltd. A vertical band chart in FIG. 7 was printed to measure a difference of density between one cycle (a) and after one cycle (b) of sleeve and by X-Rite 938 from X-Rite, Inc. An average density among the center, rear and front was ΔID.

Excellent (usable): 0.01≦ΔID

Good (usable): 0.01<ΔID≦0.03

Fair (usable): 0.03<ΔID≦0.06

Poor (unusable): 0.06<ΔID

### <Uneven Image Density>

Each of the developers was set therein, and after a solid image A4 was produced at a charged potential (Vd) of −500 V, a potential of solid image part after irradiated of −100 V and a developing bias of DC −400V, the uneven image density was observed.

Good (usable): No uneven image density is observed

Poor (unusable): Uneven image density is observed

### <Carrier Adherence (Solid Image)>

Each of the developers was set therein, and after a solid image (30 mm×30 mm) was produced at a charged potential (Vd) of −500 V, a potential of solid image part after irradiated of −100 V and a developing bias of DC −400V, the carrier on the photoreceptor was counted.

The developer had a toner concentration of 4%.

### <Carrier Adherence (Edge)>

Each of the developers was set therein, and a two dot line image (100 lpi/inch) was produced in a sub-scanning direction on a photoreceptor at a charged potential (Vd) of −700 V, an irradiated part potential of −100 V and a developing bias of DC −500V.

The two dot line image developed on the photoreceptor was transferred onto an adhesive tape having an area of 100 cm², and the carrier on thereon was counted.

The developer had a toner concentration of 9%.

Excellent (usable)

Good (usable)

Poor (unusable)

### <Resistivity Variation>

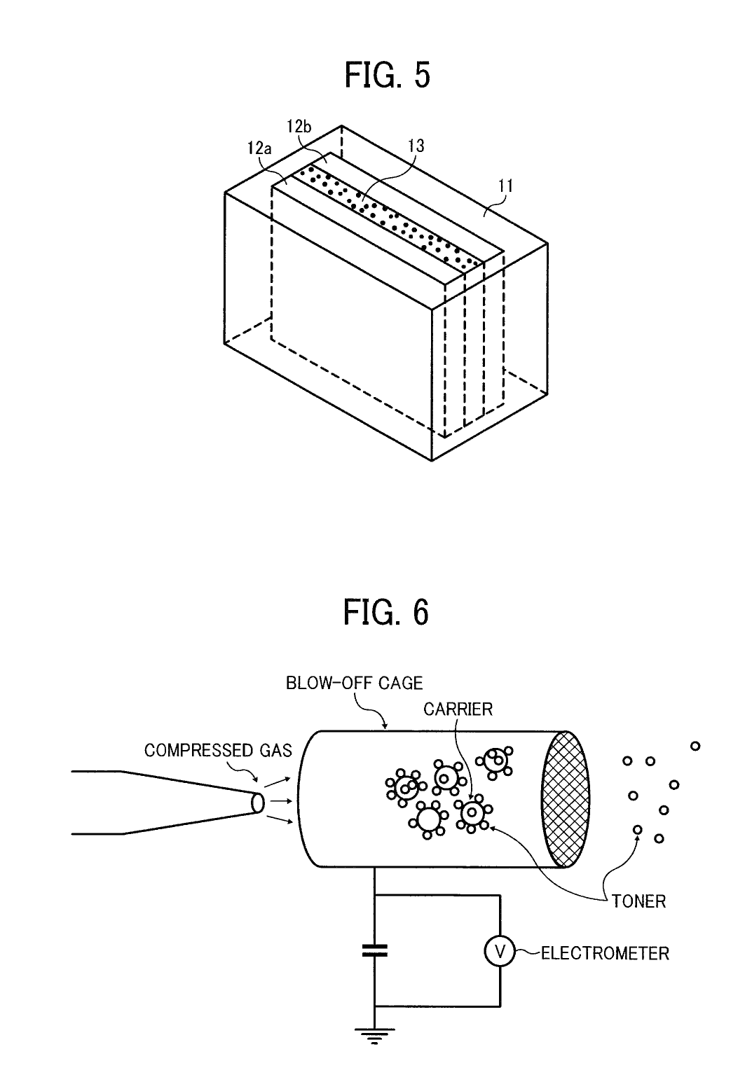

The toner was separated and removed from the developer using the apparatus in FIG. 6 with a 795 mesh to leave the carrier alone, and the resistivities thereof before and after the images were produced were measured using the apparatus in FIG. 5. The difference thereof was Δ Log R.

Excellent (usable): Δ Log R≦0.5

Good (usable): 0.5<Δ Log R≦1

Fair (usable): 1<Δ Log R≦2

Poor (unusable): 2<Δ Log R:

TABLE 1-1

| | Core Material | | | | Carrier | | | |
|---|---|---|---|---|---|---|---|---|
| | Ferrite | BET | BD | PD | BD | BET | σ5000 | σr |
| Example 1 | 1 | 0.18 | 1.84 | 35 | 1.95 | 0.9 | 74 | 0.3 |
| Example 2 | 2 | 0.15 | 2.01 | 35 | 2.06 | 0.6 | 74 | 1 |
| Example 3 | 2 | 0.15 | 2.01 | 35 | 2.15 | 1 | 73 | 1 |
| Example 4 | 2 | 0.15 | 2.01 | 35 | 2.18 | 1.8 | 72 | 0.9 |
| Example 5 | 3 | 0.13 | 2.08 | 35 | 2.18 | 1.1 | 75 | 1.2 |
| Comparative | 3 | 0.13 | 2.08 | 35 | 2.27 | 1.5 | 75 | 1.2 |
| Example 1 | | | | | | | | |
| Example 6 | 4 | 0.09 | 1.59 | 50 | 1.68 | 0.8 | 74 | 0.7 |
| Comparative | 5 | 0.11 | 1.47 | 50 | 1.58 | 0.8 | 74 | 0.6 |
| Example 2 | | | | | | | | |
| Comparative | 6 | 0.07 | 2.4 | 35 | 2.47 | 0.7 | 76 | 0.3 |
| Example 3 | | | | | | | | |
| Comparative | 7 | 0.22 | 1.94 | 35 | 2.05 | 1.1 | 65 | 0.7 |
| Example 4 | | | | | | | | |
| Comparative | 8 | 0.15 | 2.1 | 35 | 2.22 | 1 | 65 | 0.6 |
| Example 5 | | | | | | | | |
| Comparative | 9 | 0.07 | 1.9 | 35 | 2.03 | 0.7 | 67 | 6.3 |
| Example 6 | | | | | | | | |
| Comparative | 2 | 0.15 | 2.01 | 35 | 2.04 | 0.4 | 75 | 1 |
| Example 7 | | | | | | | | |
| Comparative | 2 | 0.15 | 2.01 | 35 | 2.24 | 2.1 | 70 | 0.9 |
| Example 8 | | | | | | | | |

BET: BET specific surface area
BD: Bulk Density
PD: Particle Diameter

TABLE 1-2

| | Evaluation Result | | | | | |
|---|---|---|---|---|---|---|
| | Initial | | | After 100,000 | | |
| | Ghost | UID | CA | Ghost | CA | RV |
| Example 1 | Excellent | Good | Good | Excellent | Good | Excellent |
| Example 2 | Excellent | Good | Excellent | Excellent | Good | Excellent |
| Example 3 | Excellent | Good | Excellent | Excellent | Excellent | Excellent |
| Example 4 | Good | Good | Excellent | Good | Excellent | Excellent |
| Example 5 | Good | Good | Excellent | Good | Excellent | Excellent |
| Comparative | Poor | Good | Excellent | Poor | Excellent | Excellent |
| Example 1 | | | | | | |
| Example 6 | Excellent | Good | Good | Excellent | Good | Good |
| Comparative | Excellent | Good | Poor | Excellent | Poor | Good |
| Example 2 | | | | | | |
| Comparative | Poor | Good | Excellent | Poor | Excellent | Excellent |
| Example 3 | | | | | | |
| Comparative | Good | Good | Poor | Good | Poor | Poor |
| Example 4 | | | | | | |
| Comparative | Good | Good | Good | Excellent | Poor | Fair |
| Example 5 | | | | | | |
| Comparative | Good | Poor | Good | Good | Good | Excellent |
| Example 6 | | | | | | |
| Comparative | Excellent | Good | Poor | Excellent | Poor | Poor |
| Example 7 | | | | | | |
| Comparative | Good | Poor | Excellent | Good | Excellent | Excellent |
| Example 8 | | | | | | |

UID: Uneven Image Density
CA: Carrier Adherence
RV: Resistivity Variation

The developers of Examples 1 to 6 produced ghost images having small ΔID initially and after 100,000, and had less carrier adherence and resistivity variation.

Each of the developers of Comparative Examples 1 and 3 had large ΔID, and difference of image density was visually observed.

The developers of Comparative Examples 2, 4 and 7 had serious carrier adherence, and the developer of Comparative Example 4 largely varied in resistivity.

The developer of Comparative Example 5 largely varied in resistivity, decreased the toner to thin lines, increased image density, and had serious carrier adherence.

Each of the developers of Comparative Examples 6 and 8 had small ΔID, but produced images having uneven image density.

Having now fully described the invention, it will be apparent to one of ordinary skill in the art that many changes and modifications can be made thereto without departing from the spirit and scope of the invention as set forth therein.

What is claimed is:

1. A carrier for developing electrostatic latent images, comprising:
a magnetic particulate core material; and
a covering layer covering the surface of the core material,
wherein the carrier has a bulk density of from 1.6 to 2.25 g/cm³, a BET specific surface area of from 0.5 to 2.0 m³/g, a saturated magnetization (σ5000) not less than 70 emu/g at 5 kOe, and a residual magnetization (σr) not greater than 2 emu/g.

2. The carrier of claim 1, wherein the particulate core material is a particulate manganese ferrite formed from a complex oxide combining manganese oxide and iron oxide.

3. The carrier of claim 1, wherein the particulate core material has a BET specific surface area of from 0.09 to 0.20 m³/g.

4. The carrier of claim 1, wherein the covering layer comprises a resin comprising a silicone resin.

5. The carrier of claim 1, wherein the content of the resin is from 0.5 to 7.5% by weight, based on total weight of the particulate core material.

6. The carrier of claim 1, wherein the covering layer further comprises a filler having a particle diameter of from 50 to 800 nm.

7. A developer comprising the carrier according to claim 1 and a toner.

8. A supplemental developer comprising the carrier according to claim 1 in an amount of 1 part by weight and a toner in an amount of from 2 to 50 parts by weight.

9. An image forming method, comprising:
forming an electrostatic latent image on an electrostatic latent image bearer;
developing the electrostatic latent image with the developer according to claim 7 to form a toner image;
transferring the toner image onto a recording medium; and
fixing the toner image on the recording medium.
